(19) United States
(12) Patent Application Publication
(10) Pub. No.: US 2011/0027574 A1
(43) Pub. Date: Feb. 3, 2011

(54) COATING FOR ELASTOMERIC SUBSTRATES

(75) Inventor: Patrick A. Warren, Erie, PA (US)

Correspondence Address: LORD CORPORATION;PATENT & LEGAL SERVICES, 111 LORD DRIVE, P.O. Box 8012, CARY, NC, 27512-8012, US

(73) Assignee: LORD CORPORATION, Cary, NC (US)

(21) Appl. No.: 12/933,945

(22) PCT Filed: Mar. 26, 2009
(86) PCT No.: PCT/US2009/038318

§ 371 Date: Sep. 22, 2010

Related U.S. Application Data
(60) Provisional application No. 61/039,446, filed on Mar. 26, 2008.

(51) Int. Cl. B32B 27/08; C08L 63/00; B32B 27/38

(52) U.S. Cl. 428/319.3; 523/400; 523/466; 523/468; 428/337; 428/413

(57) ABSTRACT

A coating for elastomers is provided comprising, a rubber modified epoxy resin, an epoxy reactive diluent, and an epoxy curative. The epoxy resin is modified with a carboxyl terminated butadiene acrylonitrile rubber, and the coating is capable of co-extrusion with an elastomeric substrate, such as a weatherstrip.

### CROSS REFERENCE TO RELATED APPLICATIONS

The present application claims priority under 35 U.S.C. §119(e) from U.S. Provisional Patent Application Ser. No. 61/039,446 filed Mar. 26, 2008, entitled “COEXTRUDABLE COATING FOR EXTRUDABLE SUBSTRATES”, the disclosure of which is incorporated herein by reference.

### FIELD OF THE INVENTION

The present invention relates to a low-friction coating for extruded elastomeric materials. More particularly, the present invention relates to a coating for EPDM or TPV profiles such as automotive weatherstrip, windshield wipers, door seals and the like. The present invention also relates to a method of applying the coating composition onto a substrate during the extrusion of the substrate.

### BACKGROUND OF THE INVENTION

Weatherstrip and weatherstrip coatings are generally known in the art. Weatherstrip often comprises EPDM or other elastomeric substrate and is employed to affect a seal around doors, windows, trunks, hoods and other automotive closures. The weatherstrip is often coated with a low-friction coating that provides slip to allow a surface to slide against the weatherstrip and optionally provides ice release and heat resistance for enhanced performance in extreme temperature conditions. Typically, urethane based materials are employed for elastomer coating applications due to their inherent flexibility abrasion resistance, and weatherability.

Weatherstrip is commonly formed by extrusion molding the weatherstrip, cooling the elastomeric part, and then spray applying and curing the coating. While this process can be effective, it is often labor and time intensive requiring several separate steps, and results in significant loss of coating through overspray.

It would therefore be desirable to provide a weatherstrip coating which can be co-extruded with a substrate, and is also available for application through conventional methods. Such a coating must provide high abrasion resistance, high weather resistance, good ice release characteristics and low noise. The coating must be capable of application on thermoplastic olefin compounds (TPO), thermoplastic vulcanizate compounds (TPV) and ethylene-propylene-diene-terpolymers (EPDM).

### SUMMARY OF THE INVENTION

In a first aspect of the present invention, a coating for elastomers is provided comprising, a rubber modified epoxy resin, an epoxy reactive diluent, and an epoxy curative. In a preferred embodiment of the present invention, the epoxy resin is modified with a carboxyl terminated butadiene acrylonitrile rubber. In a most preferred embodiment of the present invention, the epoxy resin comprises bisphenol A. In a further preferred embodiment of the present invention, the coating further comprises a carboxylic acid terminated butadiene rubber modified epoxidized neopentyl glycol.

In one embodiment of the present invention, the rubber modified epoxy resin is present in an amount from 30 to 90 weight percent based on the total weight of the formulation. In another embodiment of the present invention, the rubber modified epoxy resin is present in an amount greater than 40 weight percent based on the weight of the formulation.

In further alternate embodiments of the present invention, the coating is 100 percent solids, solvent free, and free of isocyanates, phenolic, and phenoxy compounds.

In an additional embodiment of the present invention, the coating further comprises a cure accelerator. In a preferred embodiment of the present invention, the cure accelerator comprises methylene diphenyl bis(dimethyl urea).

On another embodiment of the present invention, the coating further comprises a thixotrope. In a preferred embodiment of the present invention, the thixotrope comprises fumed silica. In yet another embodiment of the present inveniotnk the coating further comprises a slip agent, preferably polytetrafluoroethylene powder or ultra high molecular weight polyethylene powder.

In still another embodiment of the present invention, the coating further comprises a pigment, preferably carbon black. In another embodiment of the present invention, the coating further comprises an adhesion promoter, preferably dinitrosobenzene. In a further preferred embodiment of the present invention, the epoxy curative comprises a dicyanamide curative.

In another embodiment of the present invention, the coating is co-extruded onto substrate, preferably dense EPDM or alternatively sponge EPDM, and preferably the substrate is weatherstrip material. In two alternate embodiment of the present invention, the substrate comprises a thermoplastic olefin and a thermoplastic vulcanizate. In a further embodiment of the present invention, the substrate is a square EPDM tensile pad measuring 6 inches by 6 inches by 0.125 inches thick, and when cured the coated pad can be bent at a 180 degree angle with no visible cracking in the cured coating.

In a further aspect of the present invention, the coating comprises a two-part coating, wherein the A-side comprises a rubber modified epoxy resin, and an epoxy reactive diluent, and the B-side comprises an epoxy curative.

In an additional aspect of the present invention, an automotive weatherstrip is provided comprising a substrate and a coating wherein the substrate and coating are co-extruded to form the weatherstrip. In a preferred embodiment of the present invention, the coating comprises at least 40 percent by weight of a modified epoxy material, based on the total weight of the coating.

In an additional aspect of the present invention, a coated article is provided comprising, an elastomeric substrate, a coating comprising at least 15 weight percent of a rubber epoxy resin, and an epoxy curative, wherein the coating covers at least a portion of the substrate. In preferred embodiments of the present invention, the coating is substantially isocyanate free, and/or 100 percent solids.

In one embodiment of the present invention, the substrate is extruded and the coating is co-extruded with the substrate, preferably an EPDM substrate, and preferably the substrate comprises weatherstrip. In an additional embodiment of the present invention, the coating further comprises an epoxy curative. In another embodiment of the present invention, the coating further comprises a cure accelerator.

As will be realized by those of skill in the art, many different embodiments of a coating according to the present invention are possible. Additional uses, objects, advantages, and novel features of the invention are set forth in the detailed description that follows and will become more apparent to those skilled in the art upon examination of the following or by practice of the invention.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION

In one embodiment of the present invention, the coating is capable of co-extrusion with an elastomeric substrate, such as a weatherstrip, thereby eliminating the need for additional processing steps to coat the elastomer.

The coatings of the present invention possess many features and advantages as compared to coating of the prior art. The coatings of the present invention comprise high-solids coatings, preferably greater than 95% and most preferably 100% solids. A high solids coating allows for co-extrusion onto a substrate and reduces or eliminates emissions associated with solvent-based coatings. Further a high-solids coating applied via coextrusion approaches 100% transfer efficiency thereby reducing or eliminating waste associated with spray applied coatings.

In one preferred embodiment of the present invention, the coating composition is essentially free of isocyanates, and more preferably the composition is isocyanate free. Though isocyanates are often used in coatings for elastomers, it is preferable to construct a coating composition which is free of isocyanates to reduce health and environmental concerns.

The embodiments of the present invention provide coatings that have a low coefficient of friction, which is desirable in many applications including, for example, coatings for weatherstrip used in automobiles. For example, the weatherstrip used to provide a seal between window glass and a door frame typically has a coating with a low friction surface to allow lowering or raising of the window glass with minimum resistance. The coating on the weatherstrip also provides resistance to degradation by abrasion from movement of the window glass. In addition to having a low coefficient of friction, the coating on the weatherstrip must also remain flexible over a wide range of temperatures in order to provide a seal at temperatures of −40°C. Additionally, the coatings of the various embodiments of the present invention impart other desirable properties including itch/squeak resistance, and improved weathering resistance to the coated elastomeric weatherstrip.

In an embodiment of the present invention, the coating is applied to an elastomeric substrate. The elastomeric substrate may comprise a variety of materials including thermoplastic or thermosetting materials, including but not limited to TPE, EPDM or any combination thereof. However, in a preferred embodiment of the present invention, the coating is applied to an extrudable material.

In a preferred embodiment of the present invention, the coating comprises an epoxy-based EPDM coating. In the past, epoxy type coatings have been considered too brittle for elastomer coatings. However, the coatings of the present invention overcome this limitation through the use of a rubber modified epoxy resin. In a preferred embodiment of the present invention, the epoxy resin comprises a carboxylic acid terminated butadiene rubber modified epoxy resin.

The CTBN rubber-modified epoxy resin is produced by reacting the conventional epoxy resin as mentioned above with a CTBN rubber having a carboxyl group. The CTBN rubber having a carboxyl group includes various commercially available products. In one embodiment of the present invention, the reaction ratio of the epoxy resin and the CTBN rubber is in the range of 1/0.5 to 1/2.0 by weight (epoxy resin/CTBN rubber). The reaction is usually carried out at a temperature of 120° C. to 150° C. for 3 to 8 hours.

The epoxy resin comprises includes any conventional epoxy resins, such as glycidyl ether type epoxy resins, glycidyl ester type epoxy resins, glycidyl amine type epoxy resins, linear aliphatic epoxide type epoxy resins, alicyclic epoxide type epoxy resins, and the like, which are used alone or in combination of two or more thereof. In a preferred embodiment of the present invention, the epoxy resin comprises bisphenol A type epoxy resins and the glycidyl ether type epoxy resins.

In one embodiment of the present invention, the rubber modified epoxy rein is present in an amount from 10 to 90 weight percent based on the weight of the coating composition. In a preferred embodiment of the present invention, the rubber modified epoxy resin is present in an amount greater than 30 weight percent based on the weight of the coating composition.

In one embodiment of the present invention, the composition further comprises an epoxy reactive diluent. The epoxy reactive diluent comprises one or more compounds which have at least one oxide ring reactive with the polymerizable epoxy. In one preferred embodiment of the present invention, the reactive diluent comprises a mono-epoxy functional glycidyl ether. In one embodiment of the present invention, the diluent is added in amounts from 0 to about 25 weight percent, preferably from about 10 to about 20 weight percent of the coating composition.

In an additional embodiment of the invention, the coating composition further comprises a cure agent. The cure agent comprises a crosslinker for the epoxy resin, which can be selected from various known compounds used for cure of epoxy resins, including aliphatic amine compounds, aromatic amine compounds, polyamide compounds, acid anhydride compounds, dicyandiamide, complexes of boron trifluoride and an amine compound, phenolic and novolac resins, and the like. The cure agent can be used either singly or as a combination of multiple agents. The cure agent is present in an amount of about 2 to about 50 weight percent, preferably, about 5 to about 35 weight percent of the total composition.

In a further embodiment of the present invention, the composition further comprises a catalyst or cure accelerator to speed the reaction of the epoxy resin with the epoxy curative compound. Such catalysts are well known to those skilled in the art, and include those described in U.S. Pat. No. 5,344,856. In a preferred embodiment of the present invention, the cure accelerator comprises ureas, imidazoles, and boron trihalides with the ureas being the most preferred. In a most preferred embodiment of the present invention, the accelerator comprises methylene diphenyl bisdimethyl urea.

In further embodiments of the present invention, the cure accelerator amount may vary depending upon the desired reactivity and shelf stability. In a most preferred embodiment of the present invention, the cure accelerator is present in an amount of 0 to 5 weight percent based on the weight of the coating composition.

In a further embodiment of the present invention, a nitroso compound is added to the composition as an adhesion promoter. The nitroso compound can be any aromatic hydrocarbon, such as benzenes, naphthalenes, anthracenes, biphenyls, and the like, containing at least two nitroso groups attached directly to non-adjacent ring carbon atoms. More particularly, such nitroso compounds are described as poly-C-nitroso aromatic compounds having from 1 to 3 aromatic nuclei, including fused aromatic nuclei, having from 2 to 6 nitroso groups attached directly to non-adjacent nuclear carbon atoms. The nuclear hydrogen atoms of the aromatic nucleus can be replaced by alkyl, alkoxy, cycloalkyl, aryl, aralkyl, alkaryl, arylamine, arylnitroso, amino, halogen, and like groups. The presence of such substituents on the aromatic nuclei has little effect on the activity of the poly-C-nitroso compounds in the present invention. As far as is presently known, there is no limitation as to the character of the substituent, and such substituents can be organic or inorganic in nature. Thus, where reference is made to “DNB”, this collectively refers to poly-C-nitroso or di-C-nitroso aromatic compound, benzenes, or naphthalenes, and is understood to include both substituted and unsubstituted nitroso compounds, unless otherwise specified.

The preferred poly-C-nitroso materials are the di-nitroso aromatic compounds, especially the dinitrosobenzenes and dinitrosonaphthalenes, such as the meta- or para-dinitrosobenzenes and the meta- or para-dinitrosonaphthalenes. Particularly preferred poly-C-nitroso compounds are characterized by the formula (R).sub.m-Ar—(NO).sub.2 wherein Ar is selected from the group consisting of phenylene and naphthalene; R is a monovalent organic radical selected from the group consisting of alkyl, cycloalkyl, aryl, aralkyl, alkaryl, arylamine and alkoxy radicals having from 1 to 20 carbon atoms, amino, or halogen, and is preferably an alkyl group having from 1 to 8 carbon atoms; and m is zero, 1, 2, 3, or 4. Preferably m is zero. DNB is incorporated into the adhesive composition by addition as a solvent dispersion. The nitroso compound may be replaced by the corresponding oxime or the corresponding nitro compound with the appropriate oxidation/reduction agent.

Exemplary non-limiting embodiments of poly-C-nitroso compounds which are suitable for use in the practice of the invention include m-dinitrosobenzene, p-dinitrosobenzene, m-dinitrosonaphthalene, p-dinitrosonaphthalene, 2,5-dinitroso-p-cymeme, 2-methyl-1,4-dinitrosobenzene, 2-methyl-5-chloro-1,4-dinitrosobenzene, 2-fluoro-1,4-dinitrosobenzene, 2-methoxy-1-3-dinitrosobenzene, 5-chloro-1,3-dinitrosobenzene, 2-benzyl-1,4-dinitrobenzene, and 2-cyclohexyl-1,4-dinitrosobenzene. Amount of aromatic dinitroso compound used in the adhesive may be from 1 to 200 parts by weight per 100 parts of halogenated polyolefin and preferably from 50 to 150 parts. Nitroso compounds are typically provided as 20-45 wt. % dispersion in aromatic or chlorinated aromatic solvent.

In an additional embodiment of the present invention, other constituents may be added to provide faster curing, slip properties, viscosity control, and enhanced adhesion. Various additives such as fillers, ceramic spheres, gloss control agents, pigments, rheology modifiers, wetting agents, and the like can be used to impart various properties to the aqueous dispersion coating composition and/or the cured coating thereof.

In an embodiment of the present invention, an epoxy functional silicone is added as a friction reducing agent. Epoxy functional silicones, or epoxy silicones, such as those described in U.S. Pat. No. 4,279,717, and others are available commercially. In one preferred embodiment of the present invention, the epoxy functional silicone is present in the coating composition in an amount from 0 to about 20 weight percent based on the total weight of the composition.

In one embodiment of the present invention, one or more polyolefins and preferably polyethylenes such as powdered crystalline high temperature resistant polyethylenes are added to the composition. These materials are particularly desirable in embodiments to be used on automotive weatherstrip since they lower both the dry and wet noise level when applied to a vehicle seal. The amount of the polyolefins such as the noted polyethylene generally ranges from 0 to about 15, and preferably about 2 to about 10 weight percent based on the total weight of the composition.

The weight average molecular weight of the preferred polyethylene is generally very high and ranges from about 2 million to about 5 million and desirably from about 3 million to about 4 million and thus can be classified as an ultra high molecular weight polyethylene. The size of the polyethylene powder can vary with a mean or average particle diameter of from about 20 to about 70 microns.

Fillers are utilized to lower costs and often to lower COF and noise. Desirably the fillers are various polymers such as nylon, fumed silica, polytetrafluoroethylene, polyolefins, and silicone rubber powder. These fillers aid in reducing the coefficient of friction of the coatings of the present invention. However, with regard to noise reduction, they generally only show improved results with regard to dry noise properties.

Another class of fillers includes ceramic spheres which are generally utilized as an extender and the same are known to the art and to the literature. Suitable spheres include ceramic beads that have an average diameter of from about 1 to about 12 microns. The amount thereof is generally from about 10 or about 20 to about 35 or about 40 parts by weight per 100 parts by weight of said one or more polysiloxanes per se and said one or more polyurethanes per se.

Various gloss control agents can be utilized to lower the gloss of the cured coating. A suitable gloss control agent are known to the art and to the literature such as various synthetic wax coated silicas.

It is often desired to use various pigments so that the applied coating can generally match the color of the polymer substrate. Since weatherstrip seals are often black, various black pigment dispersions can be utilized the majority of which are various carbon blacks that are well known to the art and to the literature. The amount of such pigments can vary as from about 0.1 to about 5.0 percent by weight of the total composition.

The coatings of the embodiments of the present invention have generally been described as one-part formulations. In a further embodiment of the present invention, the coating may be packaged and sold as a two-part formulation wherein the A-side comprises the epoxy resin and the B-side comprises the cure agent. To the extent other constituents are employed with the epoxy and curative, they are generally added to the A-side, though could be included in either the A-side or B-side so long as the mixtures are shelf stable.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

### EXAMPLES

Table 1 and Table 2 provide exemplary formulations of two embodiments of the present invention that are particularly well suited for coating onto dense EPDM substrates.

TABLE 1

| | | % Of Total |
|---|---|---|
| Ingredient | Functional Purpose | formula |
| CTBN rubber modified | Film former (epoxy) | 15-30 |
| epoxy resin | | |
| Epoxy reactive diluent | Reactive diluent | 10-25 |
| CTBN rubber modified | Film former (epoxy) | 20-40 |
| epoxidized neopentyl glycol | | |
| Dicyanamide curative | Crosslinker for epoxy resin | 3-8 |
| Methylene diphenyl bis | Catalyst to allow for faster | 0-5 |
| (dimethyl urea) | curing | |
| Fumed silica | Thixotrope | 0-5 |
| PTFE powder | Slip agent | 0-5 |
| Dinitrosobenzene slurry | Adhesion promoter for | 0-10 |
| | rubber | |
| Carbon black dispersion | Pigmentation | 0-3 |
| UHMWPE powder | Slip aid | 0-8 |

TABLE 2

| | | % Of Total |
|---|---|---|
| | Functional Purpose | formula |
| Ingredient-A Side | | |
| CTBN rubber modified | Film former (epoxy) | 5-40 |
| epoxy resin | | |
| Epoxy reactive diluent | Reactive diluent | 5-30 |
| CTBN rubber modified | Film former (epoxy) | 10-40 |
| epoxidized neopentyl glycol | | |
| Fumed silica | Thixotrope | 0-10 |
| Carbon black dispersion | Pigmentation | 0-5 |
| UHMWPE powder | Slip aid/abrasion | 0-20 |
| | resistance | |
| Polyethylene Wax powder | Slip aid/abrasion | 0-20 |
| | resistance | |
| Aluminum Oxide powder | Abrasion resistance | 0-30 |
| (30 micron) | | |
| Epoxy functional silicone | Friction reducing | 0-20 |
| fluid | agent | |
| Ingredient-B-side | | |
| Polyamide resin | Crosslinker for | 90-99.9 |
| | epoxy | |
| Solvent | Solvent | 0.1-10 |

In embodiments of the present invention comprising a two-part system, the ratio of A-side to B-side may vary according to a particular application ranging from about 100:20 A-side to B-side to 100:50 A-side to B-side. Additionally, the crosslinker may be tailored to suit the particular needs of a particular application as will be understood by those skilled in the art.

Table 3 provides a specific exemplary formulation of an embodiment of the present invention that is particularly well suited for coating onto a sponge EPDM substrate, as well as ranges for alternate exemplary embodiments.

TABLE 3

| | | Amount | % of |
|---|---|---|---|
| Ingredient | Functional Purpose | (grams) | Total |
| CTBN rubber modified | Film former (epoxy) | 14.9 | 10-20 |
| epoxy resin | | | |
| Epoxy reactive diluent | Reactive diluent | 12.8 | 5-20 |
| CTBN rubber modified | Film former (epoxy) | 21.9 | 10-30 |
| epoxidized neopentyl glycol | | | |
| Polyamide crosslinker | Curative | 28.6 | 10-40 |
| Fumed silica | Thixotrope | 2.57 | 0-5 |
| Polyethylene Wax Powder | Slip aid/abrasion | 5.29 | 0-10 |
| resistance | | | |
| Carbon black dispersion | Pigmentation | 1.57 | 0-5 |
| Epoxy Functional Silicone | Friction reducing | 12.4 | 0-15 |
| Fluid | agent | | |

### Example 1

The ingredients of Formulation A were mixed together and coated on EPDM pads heated to 200° F. to simulate extruder conditions.

| | Weight |
|---|---|
| Formulation A | Percent |
| CTBN rubber modified | 21 |
| epoxy resin | |
| Epoxy reactive diluent | 18 |
| CTBN rubber modified | 32 |
| epoxidized neopentyl glycol | |
| Dicyanamide curative | 5 |
| Methylene diphenyl bis | 3 |
| (dimethyl urea) | |
| Fumed silica | 3 |
| PTFE powder | 4 |
| Dinitrosobenzene slurry | 6 |
| Carbon black dispersion | 2 |

UHMWPE powder 6

The coated EPDM pads were then subjected to standard weatherstrip tests with the following results:

| Test | Target Performance | Formulation A |
|---|---|---|
| Adhesion to | Elastomer tear via | In CA to fabric test: |
| EPDM | either crosshatch or | 14 pli 65% CA to coating |
| | cyanoacrylate test | failure; 35% fabric |
| | | stock break. |
| Naptha rub | No transfer after | Very slight transfer |
| test (20 rubs) | 20 double rubs | |
| RT Flexibility | No cracking after | Pass |
| | bending coated | |
| | pad (0.125 inches | |
| | thick tensile pad) | |
| | at 180 degree angle | |
| −40 F. | No cracking after | Pass |
| Flexibility | bending coated | |
| | pad (0.125 inches | |
| | thick tensile pad) | |
| | over 50 mm mandrel | |
| COF Static | Less than 0.3 | 0.5 |
| COF Kinetic | Less than 0.3 | 0.56 |
| Primary 3 kg. | At least 20,000 cycles | >20,000 cycles |
| Glass chisel | | |
| Abrasion | | |
| Hot H2O 3 kg. | At least 5,000 cycles | >5,000 cycles |
| Glass chisel | | |
| Abrasion | | |
| Cure cycle | Cure under customer | 5 minutes @ 204 C. |
| | line conditions | |
| Stickiness test | No adhesion of coated | Pass |
| (600 gr. Load, | rubber to glass after | |
| 1 hr. @ 176 F.) | exposure | |
| Weatherometer | Less than 3.0 Delta E | |
| Testing | after 1200 kJ of J1960 | |
| | test program | |
| 221 kj | Less than 3.0 Delta E | 2.26 |
| 442 kj | Less than 3.0 Delta E | 3.23 |
| 663 kj | Less than 3.0 Delta E | 4.13 |
| 1240 kj | Less than 3.0 Delta E | 4.35 |
| Chemical | | |
| resistance on | | |
| crockmeter | | |
| Windex | Rating >4 on AATCC | 5 |
| | scale | |
| Fantastik | Rating >4 on AATCC | 5 |
| | scale | |
| Formula 409 | Rating >4 on AATCC | 5 |
| | scale | |
| Armor All | Rating >4 on AATCC | 5 |
| Cleaner | scale | |
| Armor All | Rating >4 on AATCC | 5 |
| Protectant | scale | |
| GM Windshield | Rating >4 on AATCC | 5 |
| Wash Solvent | scale | |
| GM Tar and | Rating >4 on AATCC | 4-5 |
| Road Oil | scale | |
| Remover | | |
| Appearance | No blisters on | Slight blistering |
| after 96 hr. @ | coated part | |
| 176 F. water | | |
| immersion | | |
| Whitening after | No whitening of | Pass |
| flex at RT? | coating when flexed | |
| | on 50 mm mandrel | |
| Dry Random | Less than 3.0 Sones | 0.27 (quiet) on |
| (new spec) | | flat strip |
| Wet Random | Less than 3.0 Sones | 0.2 (quiet) on |
| (new spec) | | flat strip |
| DFT (mils) | 1 mil or less | 5.9 mils |

### Example 2

The ingredients of Formulation B were mixed together and coated on EPDM pads heated to 200° F. to simulate extruder conditions.

| | Weight |
|---|---|
| Formulation B | Percent |
| CTBN rubber modified epoxy resin | 15 |
| Epoxy reactive diluent | 13 |
| CTBN rubber modified epoxidized | 22.5 |
| neopentyl glycol | |
| Fumed silica | 2.5 |
| Carbon black dispersion | 1.5 |
| UHMWPE powder | 9 |
| Polyethylene Wax powder | 5.5 |
| Aluminum Oxide (30 micron) | 18 |
| Epoxy Functional Silicone Fluid | 13 |

To 100 grams of the above, 29.5 grams of polyamide curative were added.
The coated EPDM pads were then subjected to standard weatherstrip tests with the following results:

| Test | Target Performance | Formulation B |
|---|---|---|
| RT Flexibility | No cracking after | Pass |
| | bending coated pad | |
| | (0.125 inches thick | |
| | tensile pad) at 180 | |
| | degree angle l | |
| −40 F. | No cracking after | Pass |
| Flexibility | bending coated pad | |
| | (0.125 inches thick | |
| | tensile pad) over | |
| | 50 mm mandrel | |
| COF Static | Less than 0.3 | 0.89 |
| COF Kinetic | Less than 0.3 | 0.89 |
| Primary 3 kg. | At least 20,000 cycles | >20,000 cycles |
| Glass chisel | | |
| Abrasion | | |
| Cure cycle | Cure under customer | 2 minutes @ |
| | line conditions | 260 C. |
| Weatherometer | Less than 3.0 Delta E | |
| Testing | after 1200 kJ of | |
| | J1960 test program | |
| 221 kj | Less than 3.0 Delta E | 1.86 |
| 442 kj | Less than 3.0 Delta E | 0.45 |
| 663 kj | Less than 3.0 Delta E | 3.33 |
| 1240 kj | Less than 3.0 Delta E | 1.40 |
| Whitening after | No whitening of | |
| flex at RT? | coating when flexed | |
| | on 50 mm mandrel | Pass |
| DFT (mils) | 1 mil or less | 2.5 mils |

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

What is claimed is:

1. A coating for elastomers comprising:
a rubber modified epoxy resin;
an epoxy reactive diluent; and,
an epoxy curative.

2. The coating of claim 1, wherein the epoxy resin is modified with a carboxyl terminated butadiene acrylonitrile rubber.

3. The coating of claim 2, wherein the epoxy resin comprises bisphenol A.

4. The coating of claim 3, further comprising a carboxylic acid terminated butadiene rubber modified epoxidized neopentyl glycol.

5. The coating of claim 1, wherein the rubber modified epoxy resin is present in an amount from 30 to 90 weight percent based on the total weight of the formulation.

6. The coating of claim 1, wherein the rubber modified epoxy resin is present in an amount greater than 40 weight percent based on the weight of the formulation.

7. The coating of claim 1, wherein the coating is 100 percent solids.

8. The coating of claim 1, wherein the coating is solvent free.

9. The coating of claim 1, wherein the coating is free of isocyanates.

10. The coating of claim 1, further comprising a cure accelerator.

11. The coating of claim 10, wherein the cure accelerator comprises methylene diphenyl bis(dimethyl urea).

12. The coating of claim 1, further comprising a thixotrope.

13. The coating of claim 12, wherein the thixotrope comprises fumed silica.

14. The coating of claim 1, further comprising a slip agent.

15. The coating of claim 14, wherein the slip agent comprises polytetrafluoroethylene powder or ultra high molecular weight polyethylene powder.

16. The coating of claim 1, further comprising a pigment.

17. The coating of claim 16, wherein the pigment comprises carbon black.

18. The coating of claim 1, further comprising an adhesion promoter.

19. The coating of claim 18, where in the adhesion promoter comprises dinitrosobenzene.

20. The coating of claim 1, wherein the epoxy curative comprises a dicyanamide curative.

21. The coating of claim 1, wherein the coating is free of phenolic and phenoxy compounds.

22. The coating of claim 1, co-extruded onto substrate.

23. The coating of claim 22, wherein the substrate comprises dense EPDM.

24. The coating of claim 22, wherein the substrate comprises sponge EPDM.

25. The coating of claim 22, wherein the substrate is weatherstrip material.

26. The coating of claim 22, wherein the substrate comprises a thermoplastic olefin.

27. The coating of claim 22, wherein the substrate comprises a thermoplastic vulcanizate.

28. The coating of claim 22, wherein the substrate is a square EPDM tensile pad measuring 6 inches by 6 inches by 0.125 inches thick, and when cured the coated pad can be bent at a 180 degree angle with no visible cracking in the cured coating.

29. A two-part coating according to claim 1, wherein the A-side comprises:
a rubber modified epoxy resin; and,
an epoxy reactive diluent; and,
wherein the B-side comprises an epoxy curative.

30. An automotive weatherstrip comprising a substrate and a coating wherein the substrate and coating are co-extruded to form the weatherstrip.

31. The weatherstrip of claim 29, wherein said coating comprises at least 40 percent by weight of a modified epoxy material, based on the total weight of the coating.

32. A coated article comprising:
an elastomeric substrate;
a coating comprising at least 15 weight percent of a rubber epoxy resin; and,
an epoxy curative;
wherein the coating covers at least a portion of the substrate.

33. The article of claim 32, wherein the coating is substantially isocyanate free.

34. The article of claim 32, wherein the coating is 100 percent solids.

35. The article of claim 32, wherein the substrate is extruded and the coating is co-extruded with the substrate.

36. The article of claim 32, wherein the substrate comprises EPDM.

37. The article of claim 32, wherein the substrate comprises weatherstrip.

38. The article of claim 32, wherein the coating further comprises an epoxy curative.

39. The article of claim 32, wherein the coating further comprises a cure accelerator.
